(19) United States
(12) Patent Application Publication
(10) Pub. No.: US 2002/0134481 A1
(43) Pub. Date: Sep. 26, 2002

(54) Radial tire having a wrapped body ply with two rows of reinforcement cords

(76) Inventor: David G. Abdallah JR., Akron, OH (US)

Correspondence Address: John H. Hornickel, Chief Intellectual Property Counsel, Bridgestone/Firestone, Inc,, 1200 Firestone Parkway, Akron, OH, 44317, US

(21) Appl. No.: 09/812,293

(22) Filed: Mar. 20, 2001

(51) Int. Cl. B29D 30/08; B29C 47/00

(52) U.S. Cl. 152/526; 156/128.6; 156/244.24; 152/531; 152/558

(57) ABSTRACT

A body ply (12) comprising an elastomeric sheet (30) and a plurality of rows of reinforcement cords (32) embedded therein. The plurality of rows can comprise two parallel rows (32a, 32b) of reinforcement cords and the reinforcement cords in one row can be transversely staggered relative to the reinforcement cords in an adjacent row. To make the body ply (12), the reinforcement cords (32) are introduced into a die assembly (44) and rubber is extruded around and between the reinforcement cords. Existing equipment, namely an extrusion apparatus (40) conventionally used to manufacture steel belts or single layer body ply material, can be used to make the body ply material by providing an appropriate replacement insert (56) for its die assembly.

### FIELD OF THE INVENTION

This invention relates generally to a body ply for a pneumatic radial tire and a method of making the same.

### BACKGROUND OF THE INVENTION

A pneumatic radial tire will typically include one or more body plies forming its inner carcass. Each of the body plies extends between beads and has lateral end portions turned respectively therearound. An innerliner extends between the beads and has lateral end portions connected to the inner edges of sidewalls by suitable strips and/or splices. The outer edges of the sidewalls blend with respective ends of the tread and the tread can be reinforced with tread plies and/or belts.

During the building of a radial tire, one or more body plies are wrapped around a tire building drum over an innerliner (which was previously wrapped around the drum). The non-circumferential edges of the now cylindrically-shaped body ply are overlapped to form an axially extending seam. The remaining inner and outer carcass components (e.g., beads, splices, strips, belts, tread slabs, etc.) are then also assembled on the building drum in a suitable sequence to form a green tire. The green tire is then shaped and cured to form the completed tire.

Typically, body ply material is manufactured by calendering a single row of reinforcement cords in a rubber material. When a radial tire construction requires a double layer of reinforcement cords in the tire's inner carcass, two separate body plies are commonly used to meet this requirement.

U.S. Pat. No. 4,589,024 (owned by the assignee of the present invention) discloses an extrusion apparatus for manufacturing a circular tube of body ply material having two rows of reinforcement elements. While the body ply proposed by this patent has many advantages, including a seamless construction, the extrusion apparatus needed to produce such a body ply requires a significant initial equipment investment.

### SUMMARY OF THE INVENTION

The present invention provides a body ply which can incorporate a plurality of rows of reinforcement cords and which can be made by a relatively inexpensive retrofit of existing extrusion equipment.

More particularly, the present invention provides a body ply comprising an elastomeric sheet (e.g., rubber) and a plurality of rows of reinforcement cords embedded therein. The plurality of rows can comprise two parallel rows of reinforcement cords and the cords in one row can be transversely staggered relative to the cords in an adjacent row. Thus, if a tire construction requires multiple layers of reinforcement cords, a single body ply according to the present invention can meet this requirement.

To make the body ply of the present invention, the reinforcement cords are introduced into a die assembly and an elastomer is forced (e.g., rubber is extruded) around and between the reinforcement cords. The body ply material produced by this extrusion process is then cut to size to form the roughly rectangular body ply. Existing equipment, namely an extrusion apparatus conventionally used to manufacture steel belts or single layer body ply material, can be used to make body ply material having multiple rows of reinforcement cords simply by providing an appropriate replacement insert. The replacement insert has passages corresponding to the desired arrangement (e.g., two parallel rows) of reinforcement cords in the elastomeric sheet.

The present invention provides these and other features hereinafter fully described and particularly pointed out in the claims. The following description and drawings set forth in detail a certain illustrative embodiment of the invention. This embodiment is indicative, however, of but one of the various ways in which the principles of the invention can be employed.

### DRAWINGS

FIG. 1 is a cross-section of a radial pneumatic tire incorporating a body ply according to the present invention.

FIG. 2 is a schematic representation of the building of a green tire according to the present invention.

FIG. 3 is an enlarged cross-sectional view of the body ply.

FIG. 4 is a plan view, partly broken away and in section, of an apparatus for making the reinforced ply material of the present invention.

FIG. 5 is an enlarged sectional view taken on line 5-5 in FIG. 4.

FIG. 6 is a sectional view taken on line 6-6 in FIG. 5.

FIG. 7 is an exploded perspective view of a crosshead die of the apparatus.

FIG. 8 is an isolated perspective view of a guide insert of the crosshead die.

### DETAILED DESCRIPTION

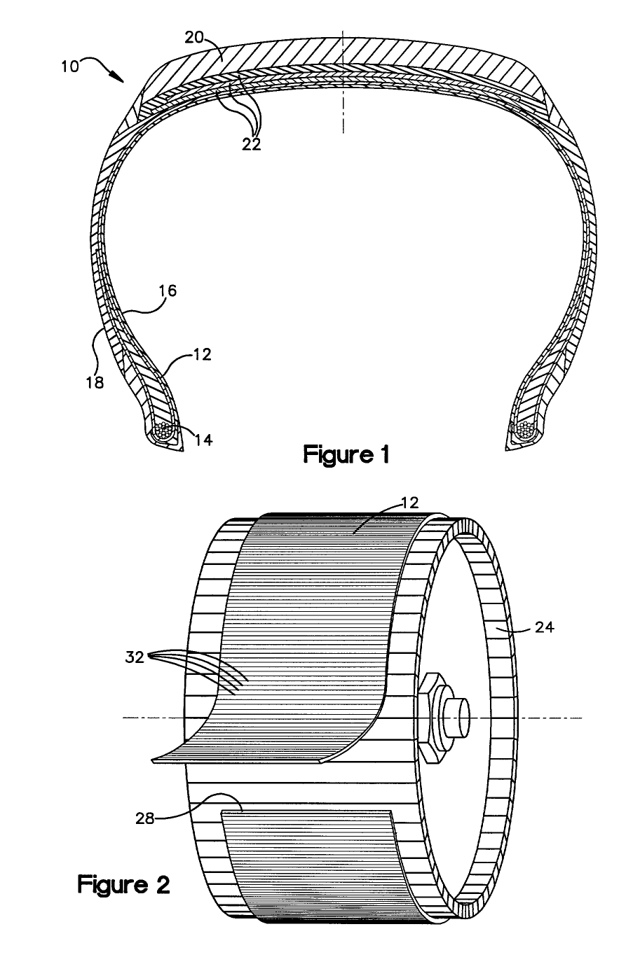

Referring now to the drawings, and initially to FIG. 1, a pneumatic tire 10 incorporating a body ply 12 according to the present invention is shown. The body ply 12 extends between beads 14 and has lateral end portions turned respectively therearound. An innerliner 16 extends between the beads 14 and its lateral end portions are connected to the inner edges of sidewalls 18 (e.g., by suitable strips and/or splices). The outer edges of the sidewalls 18 blends with respective ends of the tread 20. In the illustrated tire 10, the tread 20 is reinforced internally by tread plies 22.

Referring now to FIG. 2, the initial stages of building the pneumatic tire 10 are shown. In these stages, the body ply 12 is wrapped around a tire building drum 24 over the innerliner 16, which was previously wrapped around the drum 24. The non-circumferential edges of the now cylindrically shaped body ply 12 are overlapped or butt-spliced together to form an axially extending seam. The associated carcass components (e.g., beads, splices, strips, belts, tread plies, slabs, etc.) are then also assembled on the building drum 24 in a suitable sequence to form a green tire. The green tire is then shaped and cured to form the completed tire 10.

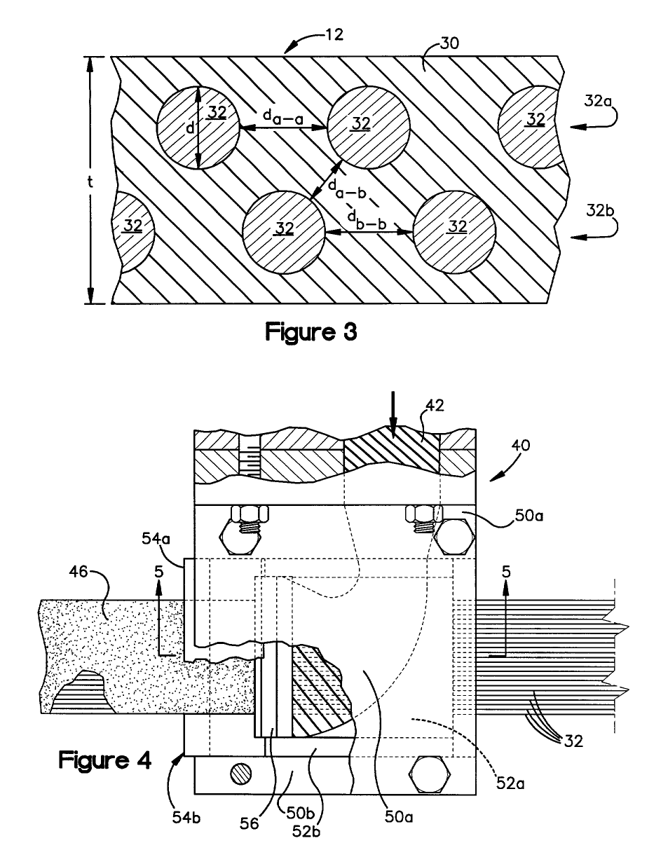

As shown in FIG. 3, the body ply material 12 comprises an elastomer sheet 30 and a plurality of reinforcement cords 32 embedded therein. In the completed tire 10, the reinforcement cords 32 extend in a direction parallel to the tire's axis. During building of the green tire, the reinforcement cords 32 extend in a direction parallel to the axis of the drum 24 and perpendicular to the axial seam.

In the body ply 12 of the present invention, the reinforcement cords are arranged in a plurality of rows thereby making stacking of multiple body plies unnecessary during tire manufacture. For example, in the illustrated body ply 12, the reinforcement cords 32 are arranged in two parallel rows 32a and 32b. Accordingly, when a tire construction requires a double layer of reinforcement cords, a single body ply 12 will meet this requirement.

In the illustrated embodiment, the elastomer sheet 30 comprises a roughly rectangular sheet of rubber. Typically, the sheet's thickness t will be about 0.5 mm to about 2.0 mm and the sheet's width w will be about 150 mm to about 250 mm. The reinforcement cords 32 can be formed from, for example, polyester, steel, fiberglass or any other suitable metal or organic textile. Typically, each row 32a/32b will comprise between about 50-600 cords 32, with each of the cords 32 having a diameter d of about 0.30 mm to about 2.0 mm. The adjacent cords in the row 32a are spaced a distance dₐ₋ₐ of about 0.1 mm to about 3.8 mm from each other and adjacent cords in the row 32b are spaced a distance d_{b-b} of about 0.1 mm to about 3.8 mm from each other. In the illustrated body ply 12, these distances are equal and uniform in the two rows 32a and 32b.

The reinforcement cords in the row 32a are spaced a distance d_{a-b} from the closest reinforcement cords in the row 32b. In the illustrated embodiment, the reinforcement cords in the row 32a are transversely staggered relative to the cords in the row 32b. However, an “unstaggered” arrangement between the reinforcement cords in adjacent rows is possible with, and contemplated by, the present invention.

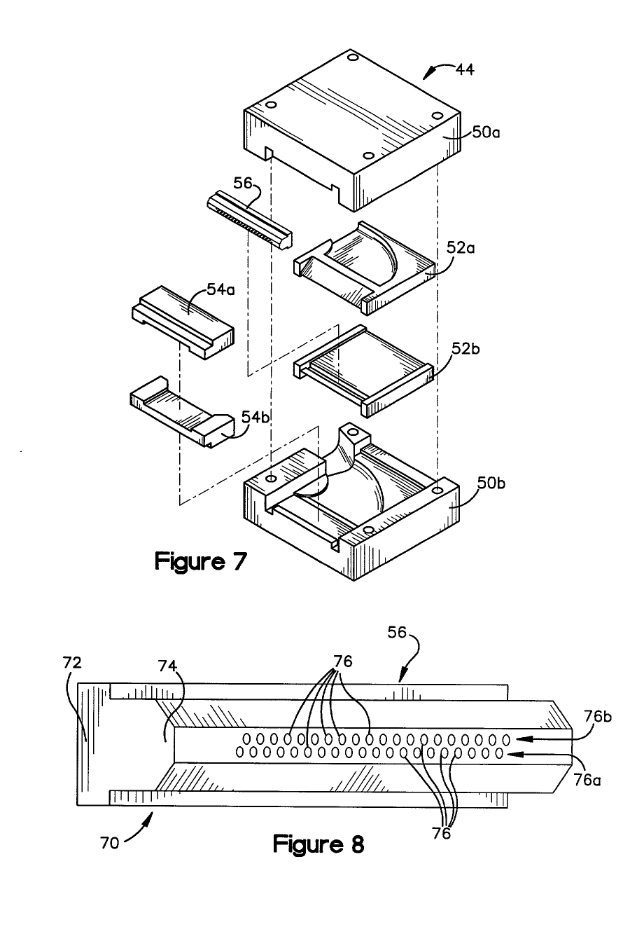

Referring now to FIGS. 4-7, an apparatus 40 for making the reinforcement ply material 20 according to the present invention is shown. The apparatus 40 includes an extruder 42 and a die assembly 44 into which an elastomer material is extruded. The reinforcement elements 32 enter the die 44 and are encapsulated with the extrude thereby forming a ribbon of reinforced ply material 46 which emerges from the opposite side of the die assembly 44.

The die assembly 44 comprises upper and lower die blocks 50a and 50b, mating die plates 52a and 52b, discharge bars 54a and 54b, and a guide insert 56. The die blocks 50 embrace the die plate 52 and the discharge bars 54 and the die plates 52 embrace the guide insert 56. Inner surfaces of the die blocks 50 and outer surfaces of the die plates 52 are complementally shaped to form an annual extrude channel 60 and a throat 62 around the die plates 52. Inner relatively flat surfaces of the die plates 52 form an emitting slot 64 from the rear of the die assembly 44 to the guide insert 56. Inner relatively flat surfaces of the discharge bars 54 form a discharge slot 66 positioned just upstream the throat 52 and the guide insert 56.

During operation of the apparatus 40, the extruder 42 delivers the elastomer material (e.g., rubber) and it flows under pressure through the channel 60, through the throat 62 and through the discharge slot 66. Simultaneously, the reinforcement elements 32 are moved though the passage 64, through the guide insert 56 and into the discharge slot 66. As the elements 32 emerge from the guide insert 56, they are encapsulated by the extrudate.

An extrusion apparatus such as the apparatus 40 is commonly used to make steel belts or a single layer body ply material for tire construction. In the die assembly 42, a removable guide insert determines the spacing and placement of the steel belt cords. According to the present invention, this insert is replaced with the guide insert 56. In this manner, the body ply 12 of the present invention can be made without requiring an initial investment for especially designed extrusion equipment.

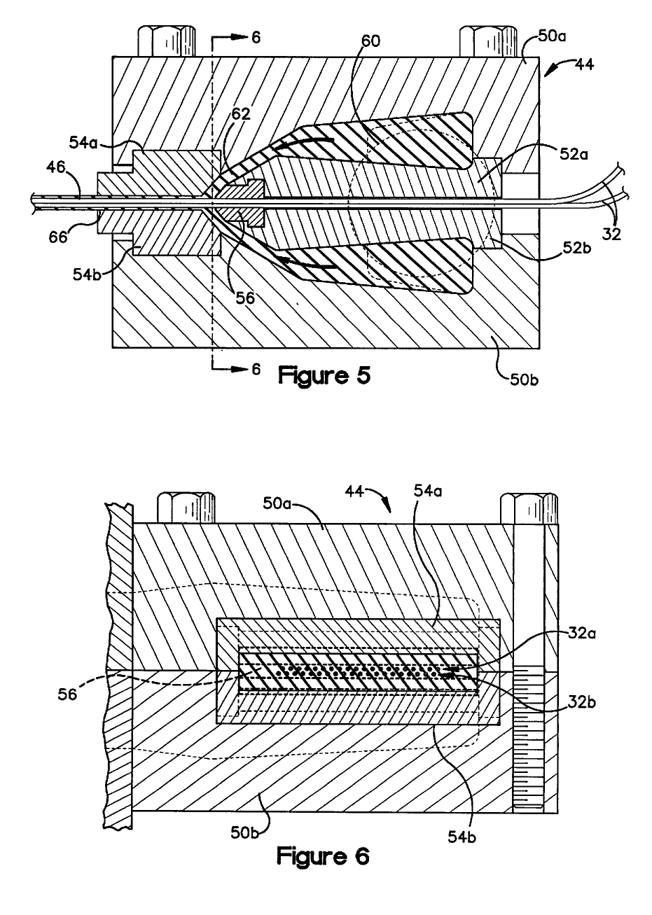

Referring now to FIG. 8, the guide insert 56 is shown isolated from the rest of the apparatus. The guide insert 56 has a body 70 having a rear portion 72 and a front portion 74, which together define guide passages 76. The insert's rear portion 72 is shaped and sized for inserted engagement with the die plates 52 and the insert's front portion 74 is shaped and sized to suitably define the die throat 62 and to accommodate the passages 76. To this end, the front portion 74 has an arrow-like shape with a flattened front. The passages 76 extend from the end wall of the rear portion 72 to the flattened apex of the front portion 74. (See FIG. 5.)

The passages 76 transversely and laterally guide the reinforcement elements 32 into the die throat 62 and thus define the position and spacing of the elements 32 in the reinforced ply material 20. Thus, in the illustrated embodiment, the passages 76 are arranged in two parallel rows 76a and 76b. The distance dₐ₋ₐ, between openings in the row 76a and the distance d_{b-b} between openings in the row 76b corresponds to the spacing between adjacent cords in the row 32a and the row 32b. (See FIG. 3.)

Also, in the illustrated embodiment, the openings in the row 76a are transversely staggered relative to the openings in the row 76b. Typically, to increase the durability and strength of a tire, two sheets of body ply material (each sheet containing a single row of reinforcement cords) are layered on top of the inner liner of the tire. In order to maintain the durability of the tire, the two rows of reinforcement cords should be spaced apart a minimum distance. The staggered design of FIGS. 1-3 allow the cords of row 32a and 32b to maintain this minimum distance of separation d_{a-b} in a single body ply of thickness t, which is less than the thickness of a conventional 2-ply configuration. The staggered pattern is further motivated by the design of the insert t cords 32 in that it increases the distance d_{a-b} between openings in row 76a and adjacent openings in row 76b thereby allowing these rows to be positioned closer together without sacrificing the structural integrity of the insert 50. (See FIG. 3.)

Accordingly, the present invention provides a body ply 12 which can incorporate a plurality of rows of reinforcement cords 32 and which can be made by an inexpensive retrofit of existing extrusion equipment. Although the invention has been shown and described with respect to a certain embodiment, it is obvious that equivalent alterations and modifications will occur to others skilled in the art upon the reading and understanding of this specification. The present invention includes all such alterations and modifications and moreover is limited only by the scope of the following claims.

1. A body ply for a pneumatic tire, comprising an elastomeric sheet and a plurality of rows of reinforcement cords embedded therein.

2. A body ply as set forth in claim 1, wherein the reinforcement cords in one row are transversely staggered relative to the reinforcement cords in an adjacent row.

3. A body ply as set forth in claim 2, wherein the plurality of rows comprise two parallel rows of reinforcement cords.

4. A body ply as set forth in claim 1, wherein the plurality of rows comprise two parallel rows of reinforcement cords.

5. A body ply as set forth in claim 1, wherein the elastomer sheet is made of rubber.

6. A body ply as set forth in claim 1, wherein the sheet has a thickness of about 0.5 mm to about 2.0 mm.

7. A body ply as set forth in claim 6, wherein the sheet has a width of about 150 mm to about 250 mm.

8. A body ply as set forth in claim 1, wherein each row comprises between about 50 to about 600 cords.

9. A body ply as set forth in claim 8, wherein the cords each have a diameter of about 0.3 mm to about 2.0 mm.

10. A body ply as set forth in claim 9, wherein the reinforcement cords in each row are spaced from adjacent reinforcement cords in the same row a distance of about 0.1 mm to about 2.0 mm.

11. A method of making the body ply of claim 1, comprising the steps of:
introducing the reinforcement cords into a die assembly; and
extruding rubber into a cavity of the die assembly so that rubber is forced around and between the reinforcement cords.

12. A method as set forth in claim 11, wherein an insert is positioned upstream of the die cavity and wherein the reinforcement cords pass through the insert.

13. A method as set forth in claim 12, wherein the insert comprises a body portion with a plurality of passages extending from an entrance end to an exit end and wherein the passages are arranged in a plurality of rows corresponding to the desired placement and spacing of the reinforcement cords.

14. A method as set forth in claim 13, wherein the passages are arranged in two parallel rows.

15. A method as set forth in claim 14, wherein the openings in one row are transversely staggered relative to the openings in the other row.

16. A method as set forth in claim 11, wherein said introducing and said extruding steps comprise:
replacing an insert in an existing machine with an insert having the passages corresponding to the arrangement of reinforcement cords in the elastomeric sheet;
passing the reinforcement cords through the replacement insert and into a die assembly of the existing machine; and
extruding rubber into a cavity of the die assembly so that rubber is forced around and between the reinforcement cords.

17. A method as set forth in claim 11, further comprising the step of cutting the body ply material to size to form the body ply.

18. A method of making the body ply of claim 1, comprising the steps of:
replacing an insert in an existing machine used to make steel belts or single layer body ply material with an insert having the passages corresponding to the arrangement of reinforcement cords in the elastomeric sheet;
passing the reinforcement cords through the replacement insert and into a die assembly of the existing machine; and
extruding rubber into a cavity of the die assembly so that rubber is forced around and between the reinforcement cords.

19. A method of building a tire comprising the steps of:
wrapping the body ply of claim 1 around a tire-building drum; and
forming a generally axially extending seam with ends of the ply.

20. A method as set forth in claim 19, wherein said forming step comprises splicing the ends of the ply to form the generally axially extending seam.

21. A green tire incorporating the body ply of claim 1, the body ply having edges forming an axially extending seam.

22. A green tire as set forth in claim 21, wherein the body ply has sliced edges forming the axially extending seam.

23. A green tire as set forth in claim 21, wherein the reinforcement cords extend substantially parallel to the axis of the green tire.

24. A tire incorporating the body ply of claim 1, the body ply extending between beads and having lateral end portions turned respectively therearound.

25. A tire as set forth in claim 24, wherein the reinforcement cords extend substantially parallel to the axis of the tire.

26. A body ply for a pneumatic tire, comprising an elastomeric sheet and two parallel rows of reinforcement cords embedded therein;
each row comprising between about 50 to about 600 cords;
each cord having a diameter of about 0.3 mm to about 2.0 mm; and
the reinforcement cords in each row being spaced from adjacent reinforcement cords in the same row a distance of about 0.1 mm to about 3.8 mm.

27. A body ply as setforth in claim 27, wherein the reinforcement cords in one row are transversely staggered relative to the reinforcement cords in an adjacent row.

28. A pneumatic tire having a body ply which comprises an elastomer sheet and two parallel rows of reinforcement cords embedded therein;
each row comprising between about 50 to about 600 cords;
each cord having a diameter of about 0.3mm to about 2.0 mm;
the reinforcement cords in each row being spaced from adjacent reinforcement cords in the same row a distance of about 0.1 mm to about 3.8 mm;
the reinforcement cords in one row being transversely staggered relative to the reinforcement cords in an adjacent row.
